(19) United States
(12) Patent Application Publication
(10) Pub. No.: US 2011/0025836 A1
(43) Pub. Date: Feb. 3, 2011

(54) DRIVER MONITORING APPARATUS, DRIVER MONITORING METHOD, AND VEHICLE

(76) Inventors: Satoshi Tamaki, Osaka (JP); Tomokuni Iljima, Kanagawa (JP)

Correspondence Address: WENDEROTH, LIND & PONACK L.L.P., 1030 15th Street, N.W., Suite 400 East, Washington, DC, 20005-1503, US

(21) Appl. No.: 12/922,880

(22) PCT Filed: Mar. 6, 2009
(86) PCT No.: PCT/JP2009/001031

§ 371 Date: Sep. 16, 2010

(30) Foreign Application Priority Data
Mar. 18, 2008 (JP) 2008-070077

(51) Int. Cl. H04N 7/18

(52) U.S. Cl. 348/78; 348/77; 348/E07.085

(57) ABSTRACT

A driver monitoring apparatus that detects a face orientation of a driver with sufficient accuracy without setting a long base-line length for a camera and without being adversely affected by disturbance. The driver monitoring apparatus (10) that monitors the face orientation of the driver includes: a supplemental illuminator (22) which illuminates the driver with near-infrared light; a compound-eye camera (21) which captures images of a face of the driver, the compound-eye camera including a plurality of lenses (211a, 211b) and an imaging device (214) having imaging areas (214a, 214b) each corresponding to one of the lenses (211a, 211b); and an ECU (30) which estimate the face orientation of the driver by processing the images captured by the compound-eye camera (21) and detecting a three-dimensional position of a feature point of the face of the driver, wherein the compound-eye camera (21) is placed in such a manner that a base-line direction coincides with the vertical direction, the base-line direction being a direction in which the lenses (211a, 211b) are arranged.

### TECHNICAL FIELD

The present invention relates to a driver monitoring apparatus mounted on a vehicle for obtaining images of a driver's face using a camera to detect a driver's status, and relates also to a driver monitoring method.

### BACKGROUND ART

Apparatuses have conventionally been proposed for capturing images of a driver's face and performing image processing using the captured images to detect the driver's face orientation and determine, based on the detection result, whether or not the driver is inattentively driving or asleep at the wheel.

For example, according to the technique disclosed in Patent Reference 1, images of a driver are sequentially captured at predetermined time intervals (sampling intervals) using a camera, and a time difference value is calculated through calculation of a difference between a captured image and a previous image captured one sampling before. An image obtained from the time difference value is a motion of the driver during the sampling interval, and from this motion the position of the driver's face is detected and the face orientation and so on are obtained through calculation.

According to the technique disclosed in Patent Reference 2, the face orientation is detected by capturing images of the driver's face using two cameras (first and second cameras) placed at different positions.

The first camera is placed on a steering column or the like to capture an image of the driver. The second camera is placed on a rear-view mirror or the like to capture an image of the driver from a direction different from that of the first camera. The image captured by the second camera includes both a reference object whose positional relationship with the first camera is known and the driver. The reference object is the first camera or the steering column, for example.

Next, the position of the driver's face and the position of the reference object are obtained through image processing. Then, using positional information on the reference object and the first camera, the distance from the first camera to the driver's face is calculated from the image captured by the second camera. The zoom ratio of the first camera is adjusted according to the calculated distance so that the image of the driver's face is appropriately captured, and based on the appropriately-captured face image, the face orientation and so on are detected.

Furthermore, according to the technique disclosed in Patent Reference 3, the face orientation is detected by capturing images of the driver's face using two cameras placed at different positions, as in the technique disclosed in Patent Reference 2.

The two cameras are placed at a distance from each other, such as on the left and right sides of the dashboard (the respective ends of the instrument panel), for example, so as to capture images of the driver from the left and right directions. The position of a feature point of a face part is estimated from two captured images, and the face orientation is detected based on the estimated position.
Patent Reference 1: Japanese Unexamined Patent Application Publication No. 11-161798
Patent Reference 2: Japanese Unexamined Patent Application Publication No. 2006-213146
Patent Reference 3: Japanese Unexamined Patent Application Publication No. 2007-257333

### DISCLOSURE OF INVENTION

### Problems that Invention is to Solve

However, in the above prior art, the face orientation cannot be detected with sufficient accuracy without being affected by disturbance and so on.

For example, the technique disclosed in Patent Reference 1 detects the position of the driver's face based on a differential image, and thus even when the face is not moved, it is erroneously detected that the driver has moved when outside light such as the sunlight brings about a change in the differential image.

Furthermore, the technique disclosed in Patent Reference 2 simplifies the driver's face into a cylindrical model in order to appropriately adjust, based on the positional relationship indicated in the image captured by the second camera, the size of the face image captured by the first camera used for the face orientation detection. Thus, the face orientation cannot be accurately detected in the case of, for example, detecting the driver turning his head to a side to look sideways, to check a side mirror, or the like. In addition, because face parts are detected through image processing such as edge extraction based on two-dimensional information on the driver's face captured by the camera, and the face orientation and so on are detected based on the detection result, it is difficult to accurately detect the face orientation when outside light such as the sunlight changes the face brightness depending on the position, because other than the edges of the eyes, the mouth, and the face contour, unnecessary edges also appear in the light-shadow boundary due to the outside light.

Moreover, although the technique disclosed in Patent Reference 3 calculates a feature point of a face part from the images of the driver captured from the left and right directions, it does not allow accurate estimation of the position of the feature point of the face part because the human face generally includes many parts having features in the lateral direction (horizontal direction). Furthermore, although extension of the base-line length of the two cameras is necessary for enhanced accuracy, it is not necessarily possible to ensure a sufficient base-line length within the narrow space of the vehicle.

In view of the above, it is an object of the present invention to provide a driver monitoring apparatus and a driver monitoring method for detecting a driver's face orientation with sufficient accuracy without setting a long base-line length for the camera and without being adversely affected by disturbance.

### Means to Solve the Problems

In order to achieve the above object, the driver monitoring apparatus according to an aspect of the present invention is a driver monitoring apparatus that monitors a face orientation of a driver, the apparatus including: an illuminator which illuminates the driver with near-infrared light; a compound-eye camera which captures images of a face of the driver, the compound-eye camera including a plurality of lenses and an imaging device having imaging areas each corresponding to one of the lenses; and a processing unit configured to estimate the face orientation of the driver by processing the images captured by the compound-eye camera and detecting a three-dimensional position of a feature point of the face of the driver, wherein the compound-eye camera is placed in such a manner that a base-line direction coincides with a vertical direction, the base-line direction being a direction in which the lenses are arranged.

With this, the base-line direction of the lenses coincides with the longitudinal direction (vertical direction) of the driver's face at the time of normally driving the vehicle, and thus the position of the face part having a feature in the lateral direction (horizontal direction) can be accurately estimated. Furthermore, having a dedicated illuminator allows detection of the face orientation without being affected by outside luminous surroundings such as the sunlight. As a result, it is possible to detect the driver's face orientation with sufficient accuracy without setting a long base-line length for the camera and without being adversely affected by disturbance. In addition, since the base-line length of the lenses is not set long, the camera and so on can be highly miniaturized.

Furthermore, the processing unit may be configured to detect, as the three-dimensional position of the feature point of the face of the driver, a three-dimensional position of a face part having a feature in a lateral direction of the face.

With this, use of a face part which, among the human face parts, particularly has a feature in the lateral direction allows easy and accurate detection of the face part from the images captured by the compound-eye camera.

For example, the processing unit may be configured to detect, as the three-dimensional position of the face part having a feature in the lateral direction of the face, a three-dimensional position of at least one of an eyebrow, a tail of an eye, and mouth of the driver.

In addition, the processing unit may include: a face model calculating unit configured to calculate the three-dimensional position of the feature point of the face of the driver, using a disparity between first images captured by the compound-eye camera; and a face tracking calculating unit configured to estimate the face orientation of the driver, using a face model obtained through the calculation by the face model calculating unit and second images of the driver that are sequentially captured by the compound-eye camera at a predetermined time interval.

With this, a disparity between a standard image, which is one of the first images, and another one of the first images is calculated to actually measure the distance to the face part and calculate three-dimensional position information on the face. This makes it possible to accurately detect the face orientation even when the driver turns his head to a side, for example.

Furthermore, the face model calculating unit may be configured to calculate the three-dimensional position using, as the disparity between the first images, a disparity in the base-line direction of the imaging areas.

With this, the calculation of the disparity in the base-line direction of the lenses enables accurate detection of the position of the face part having a feature in the lateral direction.

Moreover, the processing unit may further include a control unit configured to control the compound-eye camera so that the compound-eye camera outputs the second images to the face tracking calculating unit at a frame rate of 30 frames/second or higher.

This allows sequential detection of the face orientations.

In addition, the control unit may be configured to further control the compound-eye camera so that the number of pixels of the second images is smaller than the number of pixels of the first images.

With this, when sequentially estimating the face orientations, it is possible to maintain the frame rate of 30 frames/second or higher by reducing the number of pixels output from the compound-eye camera.

The present invention can be realized also as a vehicle including the above driver monitoring apparatus. In the vehicle according to an aspect of the present invention, the compound-eye camera and the illuminator may be placed on a steering column of the vehicle.

This allows, at all times, capturing of the images of the driver's face and monitoring of the driver's face orientation without hindering the driver's vision.

### Effects of the Invention

According to the present invention, it is possible to detect the driver's face orientation with sufficient accuracy without setting a long base-line length for the camera and without being adversely affected by disturbance.

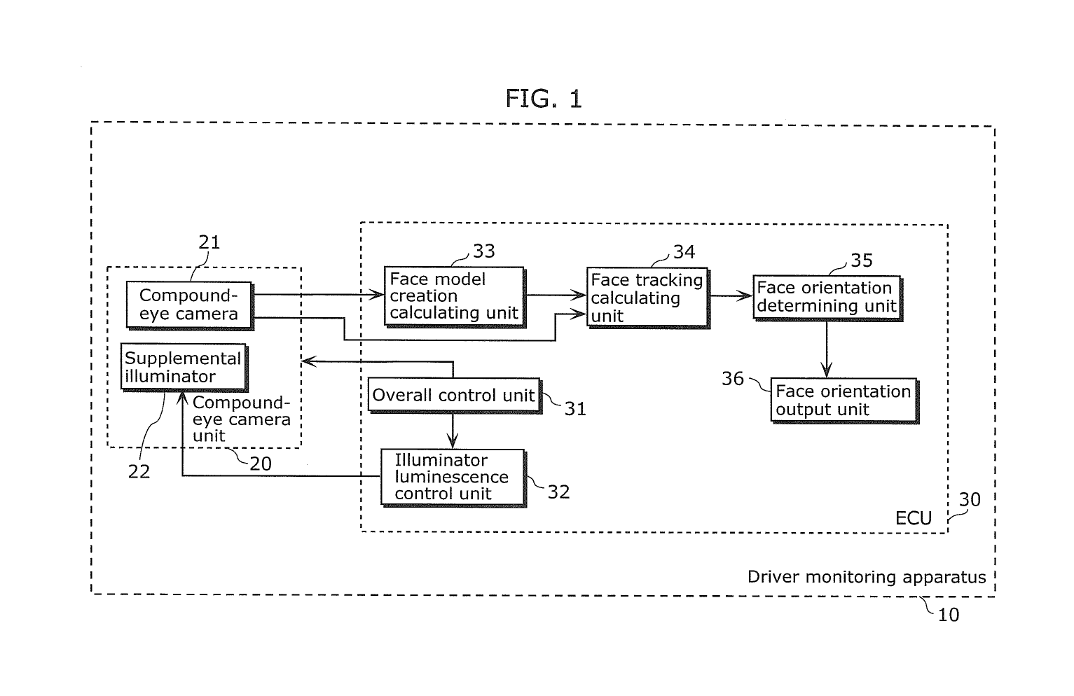

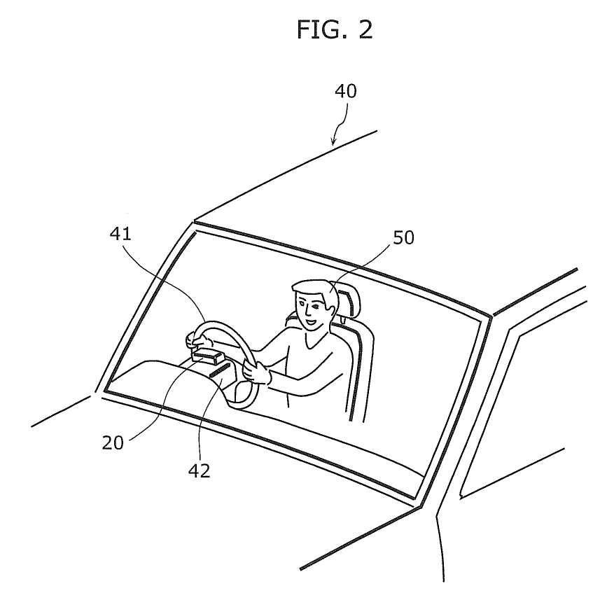

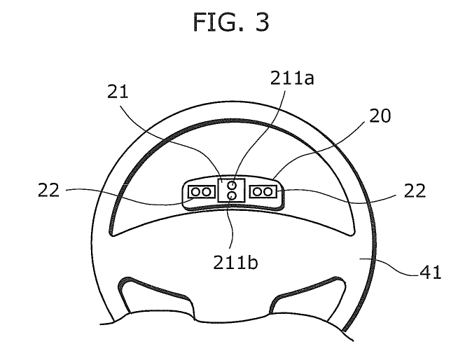

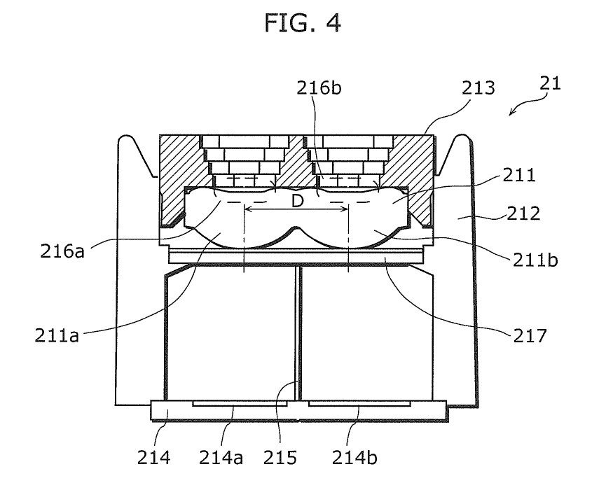

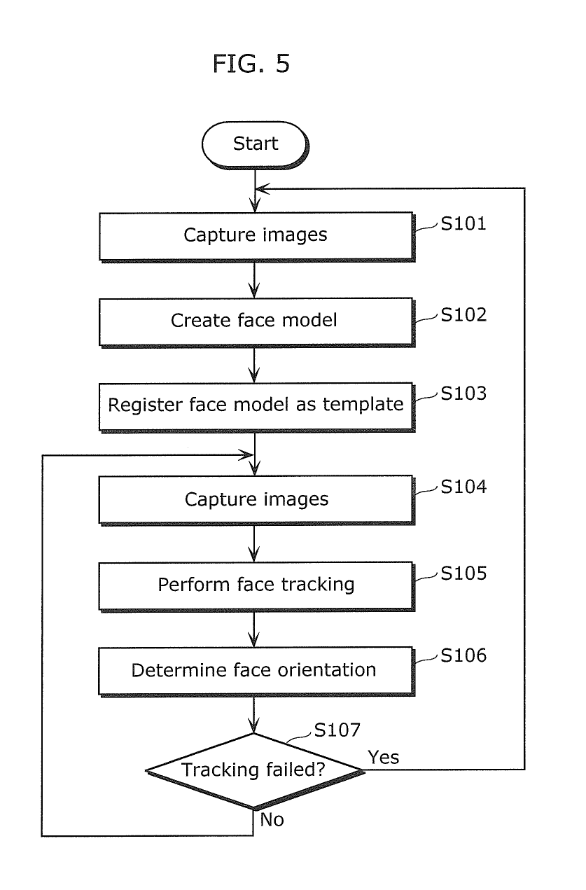

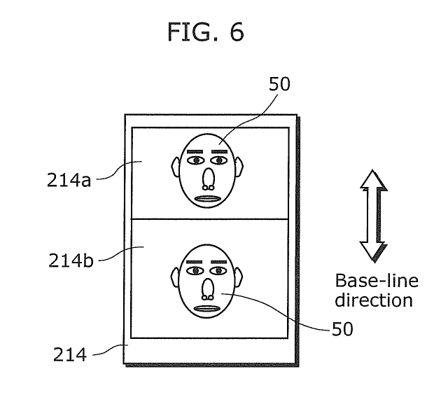

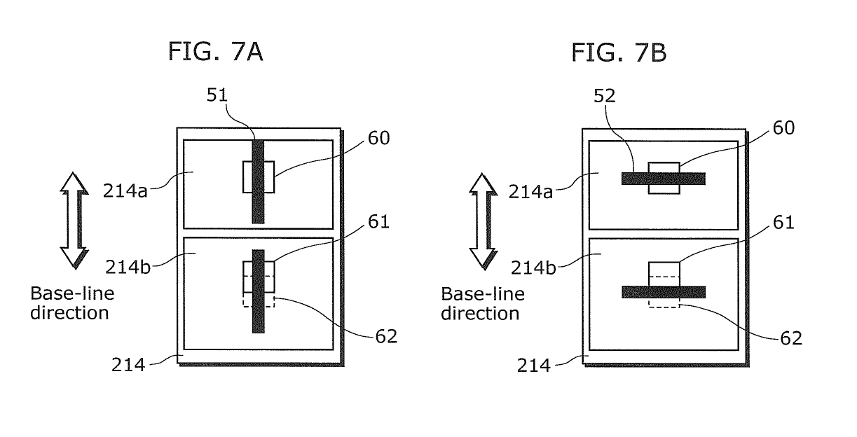

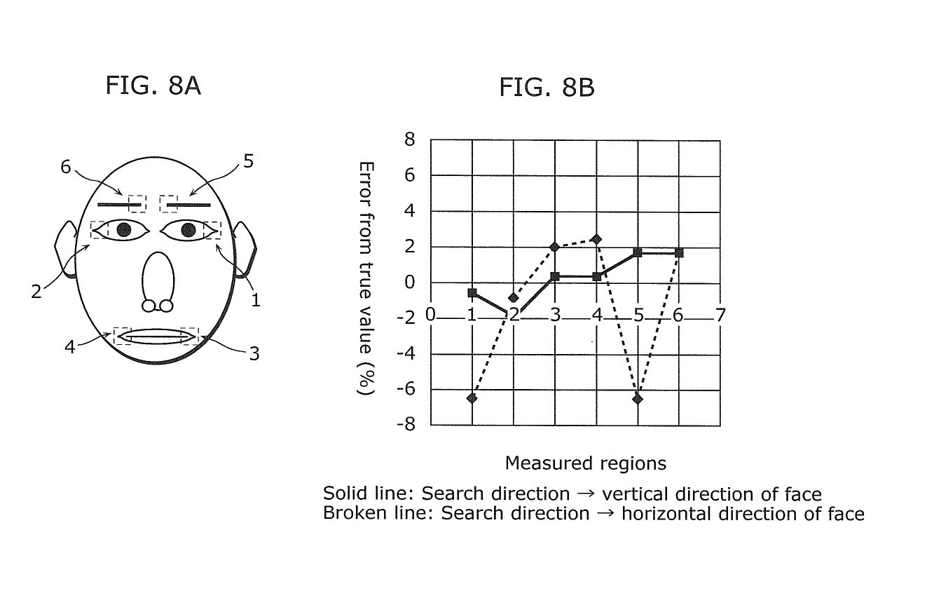

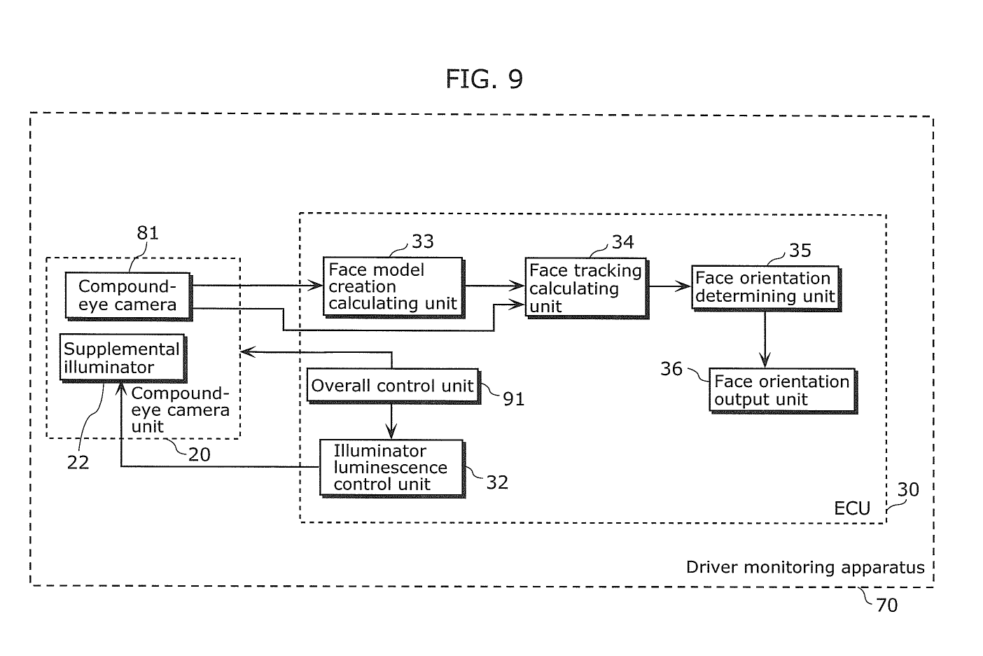

### BRIEF DESCRIPTION OF DRAWINGS

[FIG. 1] FIG. 1 is a block diagram showing a structure of a driver monitoring apparatus of Embodiment 1.

[FIG. 2] FIG. 2 is an external view showing an example of the position of a compound-eye camera unit included in a driver monitoring apparatus of Embodiment 1.

[FIG. 3] FIG. 3 is a front view of a compound-eye camera unit of Embodiment 1.

[FIG. 4] FIG. 4 is a cross-section side view of a compound-eye camera of Embodiment 1.

[FIG. 5] FIG. 5 is a flowchart showing an operation of a driver monitoring apparatus of Embodiment 1.

[FIG. 6] FIG. 6 is a schematic diagram showing an example of images captured by a compound-eye camera of Embodiment 1.

[FIG. 7A] FIG. 7A is a diagram showing an example of images obtained by capturing an object having components in a direction parallel to the base-line direction.

[FIG. 7B] FIG. 7B is a diagram showing an example of images obtained by capturing an object having components in a direction perpendicular to the base-line direction.

[FIG. 8A] FIG. 8A is a schematic diagram of a human face.

[FIG. 8B] FIG. 8B is a diagram showing differences in accuracy brought about by different search directions.

[FIG. 9] FIG. 9 is a block diagram showing a structure of a driver monitoring apparatus of Embodiment 2.

### NUMERICAL REFERENCES

10, 70 Driver monitoring apparatus
20 Compound-eye camera unit
21, 81 Compound-eye camera
22 Supplemental illuminator
30 ECU
31, 91 Overall control unit
32 Illuminator luminescence control unit
33 Face model creation calculating unit
34 Face tracking calculating unit
35 Face orientation determining unit
36 Face orientation output unit
40 Vehicle
41 Steering wheel
42 Steering column
50 Driver
51, 52 Object
60, 61, 62 Block
211 Lens array
211a, 211b Lens
212 Lens tube
213 Upper lens tube
214 Imaging device
214a, 214b Imaging area
215 Light-blocking wall
216a, 216b Optical aperture
217 Optical filter

### BEST MODE FOR CARRYING OUT THE INVENTION

Hereinafter, embodiments of the present invention are described in detail with reference to the drawings.

### Embodiment 1

The driver monitoring apparatus of the present embodiment captures images of a driver using a compound-eye camera which is placed in such a manner that the base-line direction of lenses coincides with the vertical direction. The driver monitoring apparatus monitors the driver's face orientation by processing the captured images and detecting a three-dimensional position of a feature point of the driver's face. By making the base-line direction of the lenses coincide with the vertical direction, it is possible to match the base-line direction with the longitudinal direction of the driver's face at the time of normal driving.

FIG. 1 is a block diagram showing a structure of a driver monitoring apparatus 10 of the present embodiment. As shown in FIG. 1, the driver monitoring apparatus 10 includes a compound-eye camera unit 20 and an electric control unit (ECU) 30.

The compound-eye camera unit 20 includes a compound-eye camera 21 and a supplemental illuminator 22. FIG. 2 is an external view showing the position of the compound-eye camera unit 20 included in the driver monitoring apparatus 10. As shown in FIG. 2, the compound-eye camera unit 20 is placed on a steering column 42 inside a vehicle 40, for example. The compound-eye camera unit 20 captures images of a driver 50 through a steering wheel 41 as though the compound-eye camera unit 20 looks up the driver 50 from the front. Note that the position of the compound-eye camera unit 20 is not limited to the position on the steering column 42 as long as it is a position from which the face of the driver 50 can be captured. For example, the compound-eye camera unit 20 may be placed in an upper portion of or above the windshield, or on the dashboard.

The compound-eye camera 21 receives from the ECU 30 a signal permitting to capture images, and captures images of the driver 50 based on this signal as though the compound-eye camera 21 looks up the driver 50 at about 25 degrees from the front. Depending on the position of the compound-eye camera unit 20, the compound-eye camera 21 captures the images as though it looks at the driver 50 from the front or as though it looks down the driver 50, but either case is acceptable.

The supplemental illuminator 22 illuminates the driver 50 with near-infrared light in synchronization with the signal permitting to capture images. Here, the driver 50 is illuminated with near-infrared light because visible light or the like could hinder normal driving, for example.

The structures of the compound-eye camera unit 20, the compound-eye camera 21, and the supplemental illuminator 22 are described later.

The ECU 30 is a processing unit that detects the face orientation of the driver 50 by processing the images captured by the compound-eye camera 21 and detecting a three-dimensional position of a feature point of the face of the driver 50. The ECU 30 includes an overall control unit 31, an illuminator luminescence control unit 32, a face model creation calculating unit 33, a face tracking calculating unit 34, a face orientation determining unit 35, and a face orientation output unit 36. Note that the ECU 30 is provided inside the dashboard of the vehicle 40, for example (not shown in FIG. 2).

The overall control unit 31 controls the driver monitoring apparatus 10 as a whole, including the image-capturing condition and so on of the compound-eye camera 21. For example, the overall control unit 31 outputs to the compound-eye camera 21 a signal permitting to capture images. Furthermore, the overall control unit 31 controls the illuminator luminescence control unit 32 to control the compound-eye camera 21 so that the compound-eye camera 21 captures images in synchronization with the luminescence of the supplemental illuminator 22. This is because constant luminescence of the supplemental illuminator 22 results in lower luminescence intensity, making it difficult to obtain sufficient brightness for processing images.

The illuminator luminescence control unit 32 controls the luminescence of the supplemental illuminator 22. The illuminator luminescence control unit 32 controls the timing and so on of the luminescence of the illuminator based on the control by the overall control unit 31.

The face model creation calculating unit 33 creates a face model based on the images captured by the compound-eye camera 21. Here, creating a face model is to calculate three-dimensional positions of feature points of plural face parts. In other words, a face model is information about three-dimensional positions of feature points of face parts (a distance from the compound-eye camera 21, for example). The details of the face model creation calculating unit 33 are described later.

The face tracking calculating unit 34 sequentially estimates face orientations from the successively-captured images of the face of the driver 50. For example, the face tracking calculating unit 34 sequentially estimates the face orientations using a particle filter.

More specifically, the face tracking calculating unit 34 predicts a face orientation, detecting that the face has moved in a particular direction from the position of the face in one frame previous to the current frame. Here, the face orientation is predicted based on probability density and motion history of the face orientation in the frame previous to the current frame. Then, based on three-dimensional position information on the face parts obtained by the face model creation calculating unit 33, the face tracking calculating unit 34 estimates positions to which the face parts have moved through the predicted motion, and calculates, using a technique of template matching, a correlation value between a currently-obtained image at the estimated positions and an image near the face parts which is already obtained by the face model creation calculating unit 33. In addition, the face tracking calculating unit 34 predicts plural face orientations, and for each face orientation predicted, calculates a correlation value by template matching as described above. For example, the correlation value can be obtained by calculating a sum of absolute differences or the like of pixels in a block.

The face orientation determining unit 35 determines a face orientation using the estimated face orientations and the correlation values obtained through the pattern matching for the estimated face orientations, and detects the determined face orientation as the driver's current face orientation. For example, the face orientation determining unit 35 detects a face orientation corresponding to the highest correlation value.

The face orientation output unit 36 outputs, to the outside, information related to the face orientation as necessary based on: the face orientation detected by the face orientation determining unit 35; vehicle information; information on the vicinity of the vehicle; and so on. For example, in the case where the face orientation detected by the face orientation determining unit 35 is a face orientation indicating inattentive driving, the face orientation output unit 36 sounds an alarm to alert the driver, turns on the light in the vehicle, or reduces the vehicle speed, for example.

Hereinafter, the details of the compound-eye camera unit 20, the compound-eye camera 21, and the supplemental illuminator 22 of the present embodiment are described. FIG. 3 is a front view of the compound-eye camera unit 20 of the present embodiment viewed from the driver 50.

The compound-eye camera unit 20 is placed on the steering column 42 and captures images of the driver 50 (not shown in FIG. 3) through space in the steering wheel 41. As previously described, the compound-eye camera unit 20 includes the compound-eye camera 21 and the supplemental illuminator 22.

The compound-eye camera 21 includes two lenses 211a and 211b molded into one piece with a resin. The two lenses 211a and 211b are provided in the up-down direction (vertical direction). Here, the up-down direction is a direction approximately the same as the longitudinal direction of the face of the driver 50 (line connecting the forehead and the chin).

The supplemental illuminator 22 is a light emitting diode (LED) or the like that illuminates the driver 50 with near-infrared light. As an example, FIG. 3 shows a structure including two LEDs on both sides of the compound-eye camera 21.

Next, the structure of the compound-eye camera 21 is described.

FIG. 4 is a cross-section side view of the compound-eye camera 21. The left side of FIG. 4 corresponds to the upper side of FIG. 3, and the right side of FIG. 4 corresponds to the lower side of FIG. 3. As shown in FIG. 4, the compound-eye camera 21 includes a lens array 211, a lens tube 212, an upper lens tube 213, an imaging device 214, a light-blocking wall 215, optical apertures 216a and 216b, and an optical filter 217.

The lens array 211 is formed into one piece using a material such as glass or plastic. The lens array 211 includes the two lenses 211a and 211b placed at a distance of D (mm) from each other (base-line length). For example, D is a value between 2 and 3 inclusive.

The lens tube 212 holds and secures the upper lens tube 213 and the lens array 211 that are assembled.

The imaging device 214 is an imaging sensor such as a charge coupled device (CCD) and includes many pixels arranged two-dimensionally. The effective imaging area of the imaging device 214 is divided into two imaging areas 214a and 214b by the light-blocking wall 215. The two imaging areas 214a and 214b are provided on the optical axes of the two lenses 211a and 211b, respectively.

The optical filter 217 is a filter for allowing only the light having specific wavelengths to pass through. In this example, the optical filter 217 allows passing through of only the light having the wavelengths of near-infrared light emitted by the supplemental illuminator 22.

The light entered the compound-eye camera 21 from the driver 50 passes through the optical apertures 216a and 216b provided in the upper lens tube 213, the lenses 211a and 211b, and the optical filter 217 that allows only the light having designed wavelengths to pass through, and forms images in the imaging areas 214a and 214b. Then, the imaging device 214 photoelectrically converts the light from the driver 50 and outputs an electric signal (not shown) corresponding to the light intensity. The electric signal output by the imaging device 214 is input to the ECU 30 for various signal processing and image processing.

Next, an operation of the driver monitoring apparatus 10 of the present embodiment is specifically described.

FIG. 5 is a flowchart showing an operation of the driver monitoring apparatus 10 of the present embodiment.

First, the overall control unit 31 of the ECU 30 outputs to the compound-eye camera 21 a signal permitting to capture images, and the compound-eye camera 21 captures images of the driver 50 based on this signal (S101). The face model creation calculating unit 33 creates a face model based on the captured images (S102). More specifically, the face model creation calculating unit 33 calculates, from the captured images, three-dimensional positions of plural face parts such as the eyebrows, the tails of the eyes, and the mouth.

Next, the face model creation calculating unit 33 registers the created face model as a template and outputs the template to the face tracking calculating unit 34 (S103).

When the template of the face model is registered, the compound-eye camera 21 outputs to the face tracking calculating unit 34 images of the driver 50 captured at a predetermined frame rate (S104).

The face tracking calculating unit 34 sequentially estimates face orientations, and performs face tracking through template matching using the template registered by the face model creation calculating unit 33 (S105). For the images received, the face tracking calculating unit 34 sequentially outputs to the face orientation determining unit 35 the estimated face orientations and correlation values obtained through the template matching.

The face orientation determining unit 35 determines a face orientation using the estimated face orientations and the correlation values (S106). Then, as necessary, the face orientation output unit 36 outputs, to the outside, information related to the face orientation based on the determined face orientation as described above.

Note that in the above processing, there are such cases as where the face tracking calculating unit 34 cannot obtain a correct correlation value because the driver 50 has turned his head to a side, for example. In case of such situations, the overall control unit 31 determines whether or not the face tracking has failed (S107). In the case where the face tracking has not failed (No in S107), the processing are repeated from the capturing of images of the driver 50 at the predetermined frame rate (S104) to the determination of a face orientation (S106).

In the case where the face tracking has failed (Yes in S107), images of the driver 50 are captured for creating a face model (S101) and the aforementioned processing are repeated. The determination as to whether or not the face tracking has failed is performed as often as the image-capturing. Note that the face orientation determining unit 35 may determine whether or not the face tracking has failed, based on the estimated face orientations and the correlation values.

With the above structure and method, the driver monitoring apparatus 10 of the present embodiment can accurately detect the driver's face orientation.

The following is a description of the reason why the driver's face orientation can be accurately detected by placing the compound-eye camera 21 in such a manner that the base-line direction of the compound-eye camera 21 included in the driver monitoring apparatus 10 of the present embodiment coincides with the longitudinal direction of the driver's face.

First, the following describes the processing performed by the face model creation calculating unit 33 to measure the distance to the object (driver) and calculate a three-dimensional position of a feature point of a face part based on two images captured by the compound-eye camera 21.

FIG. 6 is a diagram showing an example of images captured by the compound-eye camera 21 of the present embodiment. Since images of the driver 50 are captured using the two lenses 211a and 211b, the images obtained by the compound-eye camera 21 are two separate images of the driver 50 captured in the two imaging areas 214a and 214b of the imaging device 214.

Here, the image obtained from the imaging area 214a is assumed as a standard image, whereas the image obtained from the imaging area 214b is assumed as a reference image. The reference image is captured with a certain amount of shift from the standard image in the base-line direction, that is, the vertical direction due to a disparity. The face model creation calculating unit 33 searches the reference image in the base-line direction for a face part such as part of the tail of the left eye shown in a block of a certain size in the standard image, so as to specify a region correlated with that block of the standard image. In other words, the face model creation calculating unit 33 calculates a disparity using a technique called block matching. This allows calculation of three-dimensional position information of a face part using the disparity.

For example, the face model creation calculating unit 33 calculates a distance L (mm) from the compound-eye camera 21 to a face part using Equation 1.

L=D×f/(z×p) (Equation 1)

Here, D (mm) refers to the base-line length that is the distance between the lenses 211a and 211b. f (mm) refers to the focal length of the lenses 211a and 211b. Note that the lenses 211a and 211b are identical lenses. z (pixel(s)) refers to the amount of relative shift of a pixel block calculated through block matching, that is, the amount of disparity. p (mm/pixel) refers to the pixel pitch of the imaging device 214

Note that in calculating a disparity through block matching, the calculation time can be reduced by performing the search while shifting a block in the base-line direction pixel by pixel, because the base-line direction of the lenses used for stereoscopic viewing is set to coincide with the reading direction of the imaging device.

As described above, since the search direction is set to coincide with the base-line direction in the present embodiment, it is possible to enhance the accuracy of the disparity detection when the image in the search block contains many components in a direction perpendicular to the base-line direction.

FIGS. 7A and 7B are diagrams for explaining the block matching of the present embodiment in more detail. FIG. 7A is a diagram showing an example of images obtained by capturing an object having components in a direction parallel to the base-line direction (search direction). FIG. 7B is a diagram showing an example of images obtained by capturing an object having components in a direction perpendicular to the base-line direction (search direction).

First, with reference to FIG. 7A, the following describes a case of detecting a disparity of an object 51 having components in a direction parallel to the base-line direction. The face model creation calculating unit 33 searches the reference image captured in the imaging area 214b for the same image as that of a block 60 included in the standard image captured in the imaging area 214a. The face model creation calculating unit 33 searches the reference image for the same image as that of the block 60 by shifting a block in the base-line direction pixel by pixel. FIG. 7A shows a block 61 which is reached by shifting the block by a certain amount, and a block 62 which is reached by further shifting the block by a certain amount.

Here, the images in the blocks are all the same because the object 51 is constituted by components in the same direction as the base-line direction, and therefore the disparity cannot be accurately detected. For example, it is determined that the image of the block 60 in the standard image is the same as both the image of the block 61 and the image of the block 62 in the reference image. Therefore, the face model creation calculating unit 33 cannot accurately detect the disparity. As a result, the distance to the object 51 cannot be accurately calculated.

Next, with reference to FIG. 7B, the following describes a case of detecting a disparity of an object 52 having components in a direction perpendicular to the base-line direction. The face model creation calculating unit 33 searches the reference image captured in the imaging area 214b for the same image as that of a block 60 included in the standard image captured in the imaging area 214a. As in the case of FIG. 7A, the face model creation calculating unit 33 searches the reference image for the same image as that of the block 60 by shifting a block in the base-line direction pixel by pixel.

Here, the images in the blocks are all different because the object 52 is constituted by components in the direction perpendicular to the base-line direction, and therefore the disparity can be accurately detected. For example, the image of the block 60 is different from the image of the block 61 and the image of the block 62, and the same image as that of the block 60 can be reliably obtained when the block is shifted by a certain amount. Therefore, the face model creation calculating unit 33 can accurately detect the disparity and accurately calculate the distance to the object 52.

As indicated by the above description, it is desirable that the base-line direction of the compound-eye camera 21 is perpendicular to the direction of a characteristic part of the object in order to achieve accurate calculation of the distance to the object.

Here, observation of human face parts shows that the eyebrows, the eyes, and the mouth have many edge components in the horizontal direction as shown in FIG. 6. Therefore, in order to accurately obtain three-dimensional positions of plural face parts of the driver 50 using the compound-eye camera 21 through the technique of block matching, it is necessary to place the compound-eye camera 21 in such a manner that the base-line direction of the compound-eye camera 21 coincides with the longitudinal direction of the face. In the driver monitoring apparatus of the present embodiment, as shown in FIG. 3, the lenses 211a and 211b of the compound-eye camera 21 are placed one above the other, the reading direction of the imaging device is set in the base-line direction, and the base-line direction is set to coincide with the longitudinal direction of the face.

FIGS. 8A and 8B are diagrams for explaining, in regard to the driver monitoring apparatus of the present embodiment, differences in accuracy brought about by different base-line directions. FIG. 8A is a schematic diagram of a human face which is the object. FIG. 8B is a diagram showing differences in accuracy brought about by different search directions. Note that square regions 1 to 6 surrounded by broken lines shown in FIG. 8A are the regions in which the values on the horizontal axis of FIG. 8B have been measured.

As shown in FIG. 8B, in the case where the search direction is set in the longitudinal direction (vertical direction) of the face, error from the true value is within the range of −2% to +2% approximately. On the other hand, in the case where the search direction is set in the lateral direction (horizontal direction) of the face, error from the true value is within the range of −7% to +3% approximately. This clearly shows that the error value and the variation in the error range are smaller in the case of setting the search direction in the longitudinal direction of the face, than in the case of setting the search direction in the lateral direction of the face.

The above observation also shows that the distance to the driver 50 can be measured with excellent accuracy by placing the compound-eye camera 21 in such a manner that the search direction of the block matching, that is, the base-line direction of the compound-eye camera 21 coincides with the longitudinal direction of the face of the driver 50.

As described thus far, according to the driver monitoring apparatus 10 of the present embodiment, three-dimensional positions of face parts of the driver 50 can be accurately obtained through stereoscopic viewing using one compound-eye camera 21 having the lens array 211. In addition, by making the base-line direction of the lens array 211 coincide with the longitudinal direction of the face of the driver 50, it is possible to accurately obtain three-dimensional position information of the face parts even when the base-line length is short.

Furthermore, because the face orientation is determined based on the three-dimensional position information of the face parts, it is possible to determine the face orientation more accurately than in the case of using a system simplifying the face model, even when the illumination has significantly fluctuated due to the sunlight or even when the driver has turned his head to a side. Moreover, sufficient accuracy can be achieved even when one compound-eye camera is used, and thus the camera itself can be miniaturized.

### Embodiment 2

The driver monitoring apparatus of the present embodiment is an apparatus that performs control so that images of the driver captured for use in creating a face model are input with the number of pixels and at a frame rate different from the number of pixels and the frame rate of images of the driver captured for use in the face tracking calculation.

FIG. 9 is a block diagram showing a structure of a driver monitoring apparatus 70 of the present embodiment. The driver monitoring apparatus 70 shown in FIG. 9 is different from the driver monitoring apparatus 10 of FIG. 1 in including a compound-eye camera 81 instead of the compound-eye camera 21 and an overall control unit 91 instead of the overall control unit 31. Hereinafter, the aspects common to Embodiment 1 are omitted, and the descriptions are provided centering on the different aspects.

The compound-eye camera 81 is structured in the same manner as the compound-eye camera 21 shown in FIG. 4. In addition to performing the operation of the compound-eye camera 21, the compound-eye camera 81 can also change the number of pixels to be read by the imaging device, according to the control by the overall control unit 91. More specifically, the compound-eye camera 81 can select all-pixel mode or pixel-decimation mode for the imaging device of the compound-eye camera 81. In the all-pixel mode, all the pixels are read out, whereas in the pixel-decimation mode, the pixels are read out with some being decimated. The compound-eye camera 81 can also change the frame rate that is the intervals of the image capturing. Note that the pixel-decimation mode is a mode for decimating pixels by combining four pixels (four-pixel combining mode), for example.

In addition to performing the operation of the overall control unit 31, the overall control unit 91 controls the compound-eye camera 81 to control the images input from the compound-eye camera 81 to the face model creation calculating unit 33 and the face tracking calculating unit 34. To be more specific, when the face model creation calculating unit 33 is to create a face model by calculating three-dimensional positions of plural face parts, the overall control unit 91 controls the compound-eye camera 81 so that the mode for driving the imaging device of the compound-eye camera 81 is switched to the all-pixel mode. Furthermore, when the face tracking calculating unit 34 is to perform the face tracking calculation using the face model, the overall control unit 91 controls the compound-eye camera 81 so that the mode for driving the imaging device of the compound-eye camera 81 is switched to the pixel-decimation mode.

Moreover, the overall control unit 91 controls the compound-eye camera 81 to control the frame rate of the images input from the compound-eye camera 81 to the face model creation calculating unit 33 or the face tracking calculating unit 34. More specifically, when the compound-eye camera 81 is to input images to the face tracking calculating unit 34, it is necessary that the images are input at a frame rate of 30 frames/second or higher. This is to enable accurate face tracking.

With the above structure, it is possible to further enhance the accuracy of detecting the driver's face orientation. The reason is as follows:

First, the face tracking calculating unit 34 sequentially estimates face orientations using a particle filter as previously described. Thus, the shorter the intervals of the image input are, the easier it is to predict a motion. To accurately perform the face tracking, it is usually necessary to receive images at a frame rate of 30 frames/second or higher.

Meanwhile, the face model creation calculating unit 33 needs to accurately calculate three-dimensional positions of plural face parts, that is, the distance from the compound-eye camera 81 to plural face parts. The distance L to the face parts can be calculated using Equation 1 described above.

As is clear from Equation 1, decreasing the pixel pitch p of the imaging device and increasing the amount of disparity z allow the accuracy of the distance to be enhanced without changing the shape of the compound-eye camera 81.

However, because the angle of view of the compound-eye camera 81 does not change, decreasing the pixel pitch p of the imaging device results in a larger image size, and thus the images cannot be output at the frame rate of 30 frames/second. As a consequence, the face tracking cannot be performed.

Thus, as described above, it is necessary to change the frame rate when outputting images for creating a face model and when outputting images for the face tracking. To change the frame rate, the image size needs to be changed according to the frame rate. With the above operations, the accuracy of detecting the driver's face orientation can be further enhanced through the control performed by the overall control unit 91 so that images are input to the face model creation calculating unit and the face tracking calculating unit at different frame rates.

As described, the overall control unit 91 can enhance the accuracy of the calculation of three-dimensional position information by causing images obtained by driving the imaging device in the all-pixel mode, to be input to the face model creation calculating unit 33 when three-dimensional positions of face parts are to be calculated. Furthermore, the overall control unit 91 can ensure the accuracy of the face orientation determination by driving the imaging device in the pixel-decimation mode when the face tracking is to be performed after the three-dimensional position information is obtained, so that images are input to the face tracking calculating unit 34 at the frame rate of 30 frames/second or higher.

As described, the flexibility in selecting the imaging device can be increased by adaptively switching the modes for driving the imaging device, and thus, rather than using an unnecessarily expensive imaging device, an imaging device available on the market can be used. This reduces the cost of the compound-eye camera 81.

Although the driver monitoring apparatus and the driver monitoring method according to an implementation of the present invention have been described above based on the embodiments, the present invention is not limited to such embodiments. The scope of the present invention also includes what a person skilled in the art can conceive without departing from the scope of the present invention; for example, various modifications to the above embodiments and implementations realized by combining the constituent elements of different embodiments.

For example, although the present embodiment has shown the example of using the result of the face orientation determination for the determination as to whether or not the driver is inattentively driving, it is also possible to detect the direction of the driver's line of sight by detecting the three-dimensional positions of the driver's black eyes from the obtained images. This enables determination of the driver's line of sight, thereby allowing various driving support systems to utilize the result of the face orientation determination and the result of the sight line direction determination.

Furthermore, although the supplemental illuminator 22 illuminating the driver 50 is placed near the compound-eye camera 21 so that the supplemental illuminator 22 and the compound-eye camera 21 constitute the compound-eye camera unit 20, the position of the supplemental illuminator 22 is not limited to this, and any position is possible as long as the supplemental illuminator 22 can illuminate the driver 50 from that position. In other words, the supplemental illuminator 22 and the compound-eye camera 21 need not be integrally provided as the compound-eye camera unit 20.

Moreover, although the face model creation calculating unit 33 has detected the eyebrows, the tails of the eyes, and the mouth as feature points of face parts, it may detect other face parts as the feature points, such as the eyes and the nose. Here, it is desirable that such other face parts have horizontal components.

Since the present invention uses a small compound-eye camera, the base-line length, which is the distance between the lenses, is short. The accuracy usually degrades when the base-line length is shorter. Thus, to enhance the accuracy, the face tracking calculating unit 34 may calculate the correlation value on a per-sub-pixel basis. The same holds true for the face model creation calculating unit 33. For example, interpolation between pixels having the correlation value obtained on a per-pixel basis enables calculation of the correlation value on a per-sub-pixel basis.

The present invention can be realized as a program causing a computer to execute the above driver monitoring method. In addition, the present invention can be realized also as a computer-readable recording medium such as a CD-ROM (Compact Disc-Read Only Memory) on which the program is recorded, or as information, data, or a signal indicating the program. Such program, information, data, and signal may be distributed via a communication network such as the Internet.

### INDUSTRIAL APPLICABILITY

The present invention is applicable as a driver monitoring apparatus mounted on a vehicle for monitoring a driver, and can be used in an apparatus that prevents the driver's inattentive driving, for example.

1. A driver monitoring apparatus that monitors a face orientation of a driver, said apparatus comprising:
an illuminator which illuminates the driver with near-infrared light;
a compound-eye camera which captures images of a face of the driver, said compound-eye camera including a plurality of lenses and an imaging device having imaging areas each corresponding to one of said lenses; and
a processing unit configured to estimate the face orientation of the driver by processing the images captured by said compound-eye camera and detecting, as a three-dimensional position of a feature point of the face of the driver. a three-dimensional position of a face part having a feature in a lateral direction of the face,
wherein in said compound-eye camera, a base-line direction is set in a vertical direction, the base-line direction being a direction in which said lenses are arranged.

2. (canceled)

3. The driver monitoring apparatus according to claim 1,
wherein said processing unit is configured to detect, as the three-dimensional position of the face part having a feature in the lateral direction of the face, a three-dimensional position of at least one of an eyebrow, a tail of an eye, and mouth of the driver.

4. The driver monitoring apparatus according to claim 3,
wherein said processing unit includes:
a face model calculating unit configured to calculate the three-dimensional position of the feature point of the face of the driver, using a disparity between first images captured by said compound-eye camera; and
a face tracking calculating unit configured to estimate the face orientation of the driver, using a face model obtained through the calculation by said face model calculating unit and second images of the driver that are sequentially captured by said compound-eye camera at a predetermined time interval.

5. The driver monitoring apparatus according to claim 4,
wherein said face model calculating unit is configured to calculate the three-dimensional position using, as the disparity between the first images, a disparity in the base-line direction of the imaging areas.

6. The driver monitoring apparatus according to claim 4,
wherein said processing unit further includes
a control unit configured to control said compound-eye camera so that said compound-eye camera outputs the second images to said face tracking calculating unit at a frame rate of 30 frames/second or higher.

7. The driver monitoring apparatus according to claim 6,
wherein said control unit is configured to further control said compound-eye camera so that the number of pixels of the second images is smaller than the number of pixels of the first images.

8. A vehicle comprising the driver monitoring apparatus according to claim 1.

9. The vehicle according to claim 8,
wherein said compound-eye camera and said illuminator are placed on a steering column of said vehicle.

10. A driver monitoring method of monitoring a face orientation of a driver, said method comprising:
illuminating the driver with near-infrared light;
capturing images of a face of the driver, using a compound-eye camera including a plurality of lenses and an imaging device having imaging areas each corresponding to one of the lenses; and
estimating the face orientation of the driver by processing the images captured by the compound-eye camera and detecting, as a three-dimensional position of a feature point of the face of the driver, a three-dimensional position of a face part having a feature in a lateral direction of the face,
wherein in the compound-eye camera, a base-line direction is set in a vertical direction, the base-line direction being a direction in which the lenses are arranged.
